(19) United States
(12) Patent Application Publication
(10) Pub. No.: US 2023/0236155 A1
(43) Pub. Date: Jul. 27, 2023

(54) A LIGHT-ACOUSTIC SYSTEM AND A METHOD FOR DETECTING AN ANOMALY IN A STRUCTURE

(71) Applicant: AGENCY FOR SCIENCE, TECHNOLOGY AND RESEARCH, Singapore (SG)

(72) Inventors: Kui Yao, Singapore (SG); Weng Heng Liew, Singapore (SG); Qingqing Ke, Singapore (SG)

(21) Appl. No.: 18/011,214

(22) PCT Filed: May 31, 2021
(86) PCT No.: PCT/SG2021/050302

§ 371 Date: Dec. 19, 2022

(30) Foreign Application Priority Data
Jun. 18, 2020 (SG) 10202005825W

(51) Int. Cl. G01N 29/34; G01N 29/04

(52) U.S. Cl. CPC G01N 29/348; G01N 29/043; G01N 2291/0422

(57) ABSTRACT

A light-acoustic system and method for detecting an anomaly in a structure are provided. The system includes a light source configured to emit an excitation light and at least one excitation element attached to a surface of a structure. The at least one excitation element includes a photostrictive material and is configured to receive the excitation light for generating an oscillating strain. The oscillating strain generates an acoustic wave in the structure. The system also includes a detector configured to detect the acoustic wave.

### FIELD OF INVENTION

The present invention relates broadly, but not exclusively, to light-acoustic systems and to methods for detecting an anomaly in a structure.

### BACKGROUND

Non-contact inspections and measurements are important for the manufacturing and engineering industry. Examples of non-contact inspections and measurements include non-destructive testing (NDT), continuous machine condition monitoring, and structural health monitoring (SHM). Optical and acoustic technologies are widely used in these inspection and measurement techniques. Photo-acoustic coupling effect allows defects and anomalies to be detected by combining the characteristics of light and sound, such as in laser ultrasonic, for achieving non-contact testing with desired resolution and penetration depth.

For the existing laser ultrasonic technology, a high power nano-second pulsed laser is irradiated onto a material’s surface which causes localized thermal heating and expansion to generate acoustic waves. However, such a photo-thermal induced acoustic coupling mechanism can be inefficient, especially for metallic materials, as a significant portion of the light energy is converted into thermal energy and dissipated into the surrounding. Furthermore, the high-power laser can cause ablation to materials such as aluminium and composites, resulting in irreversible damage, which poses a safety concern in many industrial applications.

A need therefore exists to provide a light-acoustic system and an anomaly detection method that can address at least some of the above problems.

### SUMMARY

According to a first aspect, there is provided a system comprising: a light source configured to emit an excitation light; at least one excitation element attached to a surface of a structure, the at least one excitation element comprising a photostrictive material and configured to receive the excitation light for generating an oscillating strain, wherein the oscillating strain generates an acoustic wave in the structure; and a detector configured to detect the acoustic wave.

The excitation light may be modulated based on a light intensity.

The excitation light may be modulated based on an optical polarization.

The photostrictive material may comprise a ferroelectric material.

The at least one excitation element may comprise a resonance frequency based on at least one of a shape, a pattern and a dimension of the at least one excitation element.

The excitation light may be modulated at a modulation frequency based on the resonance frequency of the at least one excitation element.

The system may comprise a plurality of excitation elements and the plurality of excitation elements may be attached to the surface of the structure based on a pre-defined pattern.

The pre-defined pattern may comprise a periodicity, and the excitation light may be modulated at a modulation frequency based on the periodicity of the pre-defined pattern.

The pre-defined pattern may comprise an orientation, and a direction of propagation of the acoustic wave may be defined by the orientation of the pre-defined pattern.

The at least one excitation element may comprise a cantilever.

The acoustic wave may be an ultrasonic wave with frequency above 20 kHz.

The detector may comprise a non-contact sensor.

The detector may comprise a contact sensor disposed on the surface of the structure.

According to a second aspect, there is provided a non-destructive testing system comprising the system as described above.

According to a third aspect, there is provided a structural health monitoring system comprising the system as described above.

According to a fourth aspect, there is provided a method for detecting an anomaly in a structure, the method comprising: attaching at least one excitation element to a surface of the structure, the at least one excitation element comprising a photostrictive material; emitting, by a light source, an excitation light onto the at least one excitation element such that an oscillating strain is generated in the at least one excitation element, wherein the oscillating strain generates an acoustic wave in the structure; and detecting, by a detector, the acoustic wave for detecting an anomaly in the structure.

The method may further comprise modulating the excitation light based on a light intensity.

The method may further comprise modulating the excitation light based on an optical polarization.

The photostrictive material may comprise a ferroelectric material.

The at least one excitation element may comprise a resonance frequency based on at least one of a shape, a pattern and a dimension of the at least one excitation element.

The method may further comprise modulating the excitation light at a modulation frequency based on the resonance frequency of the at least one excitation element.

The method may comprise attaching a plurality of excitation elements to the surface of the structure based on a pre-defined pattern.

The pre-defined pattern may comprise a periodicity, and the method may further comprise modulating the excitation light at a modulation frequency based on the periodicity of pre-defined pattern.

The pre-defined pattern may comprise an orientation, and detecting the acoustic wave may comprise detecting along a direction of propagation of the acoustic wave defined by the orientation of the pre-defined pattern.

The detector may comprise a non-contact sensor.

The detector may comprise a contact sensor disposed on the surface of the structure.

According to a fifth aspect, there is provided a non-destructive testing method comprising the method as described above.

According to a sixth aspect, there is provided a structural health monitoring method comprising the method as described above.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 is a block diagram of a light-acoustic coupling system, according to an example embodiment.

FIG. 2 is a schematic representation of a set-up to generate and detect an oscillating strain.

FIG. 3(a) shows an example result of applying a modulation frequency sweep on the excitation element of FIG. 2.

FIG. 3(b) shows deflection of the excitation element of FIG. 2 at its resonance frequency.

FIG. 4 shows a graph comparing deflection of the excitation element of FIG. 2 based on different materials.

FIG. 5, comprising FIGS. 5(a) and 5(b), shows an assembly of a light-acoustic coupling system according to an example embodiment.

FIG. 6, comprising FIGS. 6(a) and 6(b), shows example results of applying the light-acoustic coupling system of FIG. 5 to detect acoustic wave in the structure.

FIG. 7(a) shows an assembly of a light-acoustic coupling system for anomaly detection according to another example embodiment.

FIGS. 7(b) and 7(c) show example results of applying the light-acoustic coupling system of FIG. 7(a) to detect defects in the structure.

FIG. 8 is a schematic representation of a light-acoustic coupling system comprising ferroelectric material and polarized excitation light, according to another example embodiment.

FIG. 9 is a schematic representation of a light-acoustic coupling system comprising a plurality of excitation elements, according to another example embodiment.

FIG. 10 is a schematic representation of an anomaly detection method according to a light-acoustic coupling system comprising a contact sensor, according to another example embodiment.

FIG. 11 shows a flow chart illustrating an anomaly detection method according to an example embodiment.

### DETAILED DESCRIPTION

Embodiments will be described, by way of example only, with reference to the drawings. Like reference numerals and characters in the drawings refer to like elements or equivalents.

Acoustic wave can be excited by way of photostrictive effect. A photostrictive effect is light-matter interaction that can result in non-thermal induced deformation. Photostrictive materials may be able to exhibit anisotropic photostrictive effect induced by combination of bulk photovoltaic and converse piezoelectric effects. Although photostrictive effect has been demonstrated in generating static or low frequency oscillating strains (<100 Hz) under illumination of incident light source, the static or low frequency oscillating strains are unsuitable for practical acoustic applications such as non-destructive testing. In addition, the photostrictive effect may be insufficient for photo-acoustic applications. However, illumination of incident light on the photostrictive material with matching light modulation frequency and structural resonance frequency may be able to generate acoustic wave for photo-acoustic applications.

Embodiments of the invention provide a light-acoustic coupling system and a method for using the system for non-destructive testing and structural health monitoring. The light-acoustic system may include an excitation light source, and an excitation element comprising a photostrictive material, and an acoustic wave detector. A structure/object under test or monitoring is mechanically coupled with the excitation element. The excitation light can generate strain in the excitation element, the strain can excite an acoustic wave in the structure, and the acoustic wave can be detected by the detector. The excitation light may be modulated at a selected frequency and the modulation frequency of the excitation light can match the working frequency of the excitation element which has a specified geometrical shape, pattern, and dimension for enhancing the photostrictive strain and the acoustic wave in the structure. The excited acoustic wave propagating in the structure can be sensitive to defects and anomalies, thus the light-coupling system may facilitate light-acoustic non-destructive testing and structural health monitoring.

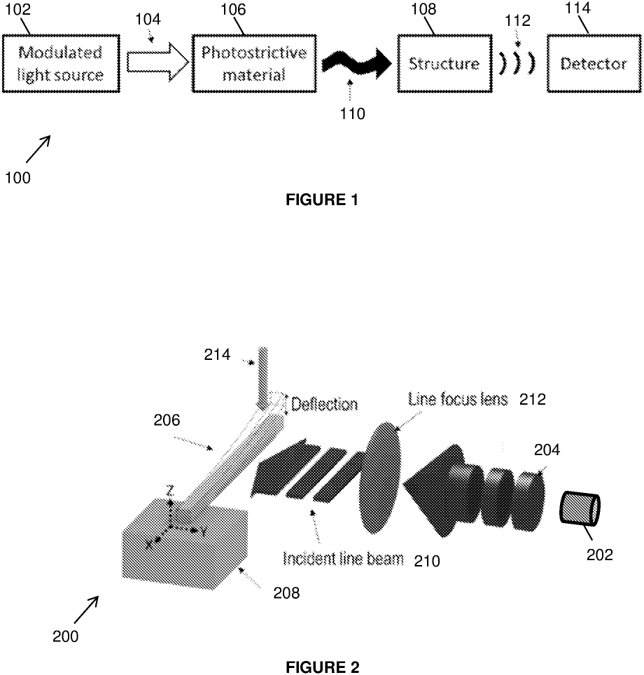

FIG. 1 is a block diagram of a light-acoustic coupling system 100, according to an example embodiment. The system 100 comprises a light source 102 configured to emit an excitation light 104. The system 100 also comprises at least one excitation element 106 attached to a surface of the structure 108. The at least one excitation element 106 comprises a photostrictive material and is configured to receive the excitation light 104 for generating an oscillating strain 110. The oscillating strain 110 generates an acoustic wave 112 in the structure 108. The system 100 further comprises a detector 114 configured to detect the acoustic wave 112 in the structure 108. In some cases, a human operator or an artificial intelligence-enabled computer can interpret the detected acoustic wave signal to determine whether there is an anomaly (e.g. a defect, an impurity, etc.) in the structure 108.

As mentioned above, the system 100 can generate acoustic wave 112 in the structure 108 mechanically coupled with the at least one excitation element 106 by using a modulated excitation light source 102. In example implementations, the system 100 can generate the acoustic wave 112 with frequency in the range of kHz to MHz in the structure 108 mechanically coupled with the at least one excitation element 106. The system 100 can be applied to the structure 108 for acoustic wave related applications such as non-destructive testing (NDT).

A low power excitation light source 102 (< 1 W, for example, 100 mW) can be used with the excitation element 106 for generating the acoustic wave 112. The required power of the excitation light source 102 may be lower than a laser power (peak power in the range of MW) used in a conventional laser ultrasonic system. As such, embodiments of the invention can improve ease of detecting anomalies and defects in structures 108 of interest.

Further, acoustic wave frequency in the system 100 can be precisely controlled with only a narrow band of frequency range being excited. The frequency may be determined by at least one of the dimension, shape and pattern of the excitation element. This is in contrast to broadband thermal-strain induced laser ultrasonic. Therefore, robustness of the system 100 can be enhanced.

The photostrictive material can exhibit photostrictive effect induced by coupling of directional bulk photovoltaic and converse piezoelectric effects. As described, the oscillating strain 110 can be generated in the excitation element 106 by the excitation light 104 emitted by the modulated excitation light source 102.

According to one embodiment, the excitation light 104 can be modulated based on a light intensity. According to another embodiment, the excitation light 104 can be modulated based on an optical polarization.

The photostrictive material of the at least excitation element 106 may comprise a ferroelectric material. The at least one excitation element 106 may comprise a resonance frequency based on at least one of a shape, a pattern and a dimension of the at least one excitation element 106. In other words, the at least one excitation element 106 can be constructed with a suitable geometry to generate the acoustic wave 112 in the structure 108 mechanically attached with the at least one excitation element 106 with desired acoustic characteristics. The desired acoustic characteristics may include a pre-defined frequency, propagation direction and intensity.

According to an embodiment, the excitation light 104 may be modulated at a modulation frequency based on the resonance frequency of the at least one excitation element 106. When the at least one excitation element 106 is illuminated by the excitation light 104 at a frequency matching the designed working frequency of the excitation element 106, the excitation element 106 can generate an enhanced strain and excite an acoustic wave 112 with maximum amplitude in the structure 108, with the center frequency matching the frequency of the excitation light 104.

In example implementations, the acoustic wave 112 excited via the photostrictive effect can reach a high frequency of above 20 kHz, which is in ultrasonic wave range. Further, by using excitation element(s) 106 of a pre-defined geometry, acoustic waves of desired acoustic characteristics can be generated. This can allow optimization of the system 100.

In addition, safety of applications of the system 100 can be improved as the excitation elements 106 are replaceable or disposable elements. Any damage to the excitation elements 106 may not compromise safety or integrity of the structure 108. As such, the system 100 can be utilized for testing and monitoring applications such as non-destructive testing (NDT) and structural health monitoring (SHM).

In the following passages, developments relating to such a system as well as example applications of the system are described in detail.

FIG. 2 is a schematic representation of a set-up 200 to generate and detect an oscillating strain. The set-up 200 may comprise a UV laser 202 as the excitation light source, a ferroelectric PMN-PT single crystal 206 (0.70Pb(Mg_{⅓}Nb_{⅔})O₃-0.30PbTiO₃, perovskite structure) as the excitation element, an alumina plate 208 as the structure mechanically coupled with the excitation element and a laser vibrometer (LSV) 214 as the acoustic wave detector. The PMN-PT crystal 206 may be polar, with polarization orientated along Z-direction as shown in FIG. 2. The PMN-PT crystal 206 can have a bulk photovoltaic effect wherein an electric potential can be generated under light illumination, and a converse piezoelectric effect wherein a strain may be generated under an electric field. Combination of the bulk photovoltaic effect and the converse piezoelectric effect can result in the photostrictive effect.

As shown in FIG. 2, the PMN-PT crystal 206 may be attached to the alumina plate 208 using an epoxy at one end forming a PMN-PT cantilever configuration. The UV laser 202 may have a wavelength of 405 nm and an average laser power of 200 mW. The excitation light 204 can be focused into a line beam 210 using a line focus lens 212 for effective excitation of the photostrictive strain. For example, the line beam 210 can illuminate either only the lower or upper half of the PMN-PT cantilever to induce a photostrictive strain in the PMN-PT cantilever. The displacement of the PMN-PT cantilever can be measured by the LSV probing laser, which may be disposed perpendicular to the excitation light beam 210 as shown in FIG. 2.

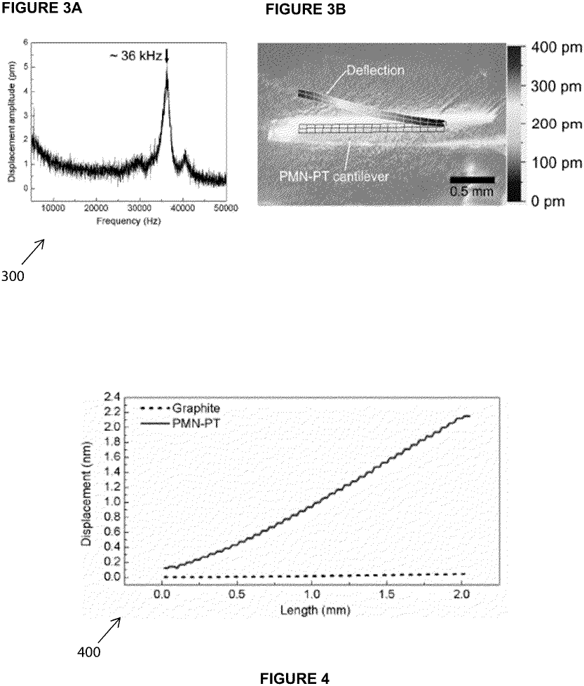

The intensity of the excitation light 204 can be modulated by a function generator (not shown). A modulation frequency sweep can first be performed on the PMN-PT cantilever to determine the structural resonance frequency of the PMN-PT cantilever. The structural resonance frequency can be controlled by changing the dimensions of the PMN-PT cantilever. For example, the resonance frequency can be increased to above 20 kHz by shortening the length of the PMN-PT cantilever. In this example, the structural resonance frequency of the PMN-PT cantilever is approximately 36 kHz. Hence, the light intensity of the excitation light 204 can be modulated at a frequency of 36 kHz to obtain maximum vibration magnitude. FIG. 3(a) shows an example result of applying a modulation frequency sweep on the excitation element of FIG. 2. Displacement amplitude of the PMN-PT cantilever against light intensity modulation frequency is shown in FIG. 3(a). FIG. 3(b) shows deflection of the excitation element of FIG. 2 at its resonance frequency. Deflection of the PMN-PT cantilever at the fundamental structural resonance as measured by the LSV is shown in FIG. 3(b).

In order to compare the photo-acoustic effect based on photostrictive and photo-thermal effects using modulated excitation light, a graphite cantilever with similar dimension as the PMN-PT cantilever can be used as a control. The graphite cantilever may exhibit photo-thermal effect but not photostrictive effect like the PMN-PT crystal 206. As such, the deflection of the graphite cantilever by the excitation light is expected to be mainly derived from the conventional photo-thermal effect.

FIG. 4 shows a graph 400 comparing deflection of the excitation element of FIG. 2 based on different materials, namely PMN-PT and graphite. As shown in the figure, the PMN-PT cantilever can achieve a maximum deflection of approximately 2.1 nm, which is more than 40 times larger in magnitude as compared to the graphite cantilever which can achieve a maximum deflection of approximately 50 pm. Hence, PMN-PT cantilever can generate a significantly improved acoustic wave with much lower power (< 1 W) as compared to conventional laser ultrasonic based on photo-thermal effect, which the peak power can be in the range of MW.

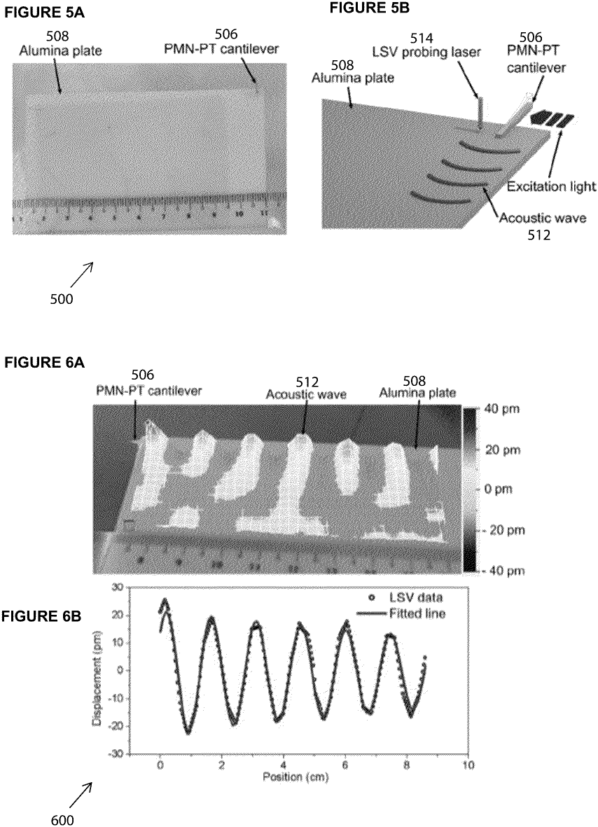

FIG. 5, comprising FIGS. 5(a) and 5(b), shows an assembly 500 of a light-acoustic coupling system according to an example embodiment. The generation of acoustic wave 512 by the PMN-PT cantilever 506 in the mechanically coupled structure can be demonstrated on the alumina plate 508. The dimension of the alumina plate 508 in this example can be 100 mm x 100 mm x 0.6 mm. The PMN-PT cantilever 506 with dimension of 2 mm (length) x 0.25 mm (width) x 0.5 mm (height) may be attached to the alumina plate 508. The incident UV light with light intensity modulated at the structural resonance frequency of the PMN-PT cantilever 506 and focused into a line beam may be directed onto the lower half of the PMN-PT cantilever 506 as shown in FIG. 5(b). The acoustic wave 512 excited by the vibration of PMN-PT cantilever 506 and transferred into the alumina plate 508 can be detected by the LSV probing laser 514.

FIG. 6, comprising FIGS. 6(a) and 6(b), shows example results 600 of applying the light-acoustic coupling system of FIG. 5 to detect the acoustic wave in the structure. Specifically, FIG. 6(a) shows an LSV area scan of the alumina plate 508 illustrating the propagation of acoustic wave 512 in the alumina plate 508. When the PMN-PT cantilever 506 is illuminated by the modulated excitation light 504, the LSV area scan shows that the acoustic wave 512 is propagating on the alumina plate 508, with a defined periodicity. The profile analysis of the LSV data can be fitted with a damped sine function as shown in FIG. 6(b), which simulates the decaying acoustic wave 512 propagating in the alumina plate 508. The wavelength of the resulting acoustic wave 512 in the alumina plate 508 may be approximately 13 mm, and the frequency of the acoustic wave 512 may be detected at approximately 36 kHz, that is, an ultrasonic wave above 20 kHz that can match the modulation frequency of the excitation light 504.

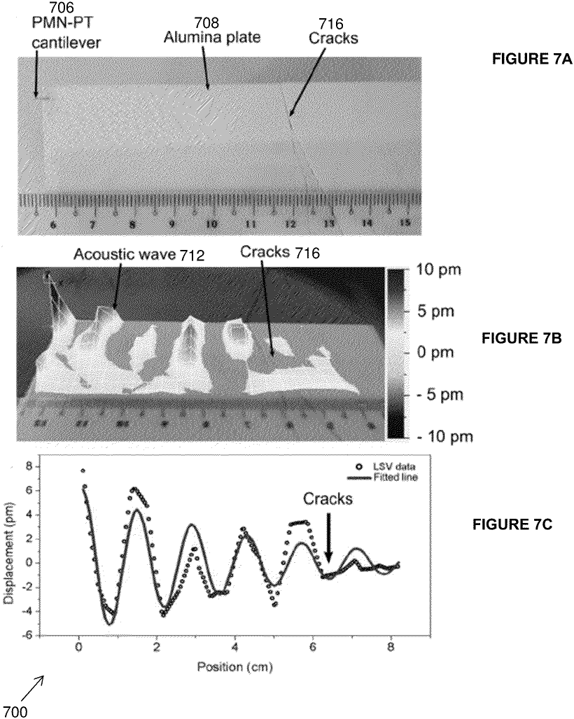

FIG. 7(a) shows an assembly of a light-acoustic coupling system for anomaly detection according to another example embodiment. Non-destructive testing function utilizing the acoustic wave 712 generated by the PMN-PT cantilever 706 in the mechanically coupled structure, for example an alumina plate 708, can be demonstrated by introducing a defect such as a crack 716 in the structure. FIG. 7(a) shows a photograph of an alumina plate 708 with cracks 716 introduced by exerting an impulse as structural defects.

FIGS. 7(b) and 7(c) show example results of applying the light-acoustic coupling system of FIG. 7(a) to detect defects in the structure. The acoustic wave 712 transferred into the alumina plate 708 with cracks 716 by the photostrictive PMN-PT cantilever 706 is shown in FIG. 7(b). The profile analysis of the acoustic wave 712 as shown in FIG. 7(c) indicates that the intensity of the acoustic wave 712 may drop significantly when propagating through the cracks 716. In contrast with the alumina plate without any crack, the detected acoustic wave 712 in the alumina plate 708 with cracks 716 can differ greatly from the simulated waveform due to the blocking and reflection of the acoustic wave 712 at the cracks 716. Hence, cracks 716 on alumina plate 708 can be detected by measuring or detecting the acoustic wave 712 in the alumina plate 708 generated by the PMN-PT cantilever 706.

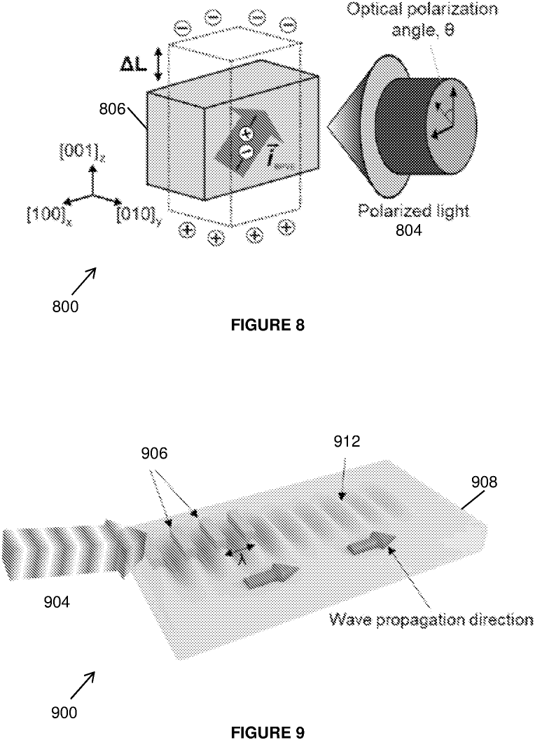

FIG. 8 is a schematic representation of a light-acoustic coupling system 800 comprising ferroelectric material and polarized excitation light, according to another example embodiment. The photostrictive material of the excitation element 806 can be selected from a group of materials exhibiting ferroelectricity, namely ferroelectric materials, and the optical polarization of excitation light 804 can be modulated to generate oscillating strain in the excitation element 806. The ferroelectric material of the excitation element 806 can have a tetragonal crystal structure. The dependence of photostrictive strain on the polarization of light and tetragonal crystal structure of the excitation element 806 can be represented by the following formula.

$$\frac{Δ \text{L}}{\text{L}} = \text{Z} ∗ \text{I} ∗ \left[\begin{matrix}{d}_{31} * \left({β}_{31} * {sin}^{2} θ + {β}_{33} * {cos}^{2} θ\right) \\ {d}_{31} * \left({β}_{31} * {sin}^{2} θ + {β}_{33} * {cos}^{2} θ\right) \\ {d}_{33} * \left({β}_{31} * {sin}^{2} θ + {β}_{33} * {cos}^{2} θ\right) \\ {d}_{15} * {β}_{15} sin θ ∗ cos θ \\ θ \\ 0\end{matrix}\right]$$

Strains in different forms, including longitudinal and shear strains, and in different directions can be induced based on the polarization angle of the excitation light 804. The directional dependence can be utilized to control deformation of the excitation element 806 and resulting acoustic wave modality. This can be achieved by changing the angle of the light’s polarization against the excitation element’s 806 crystallographic symmetry. The tensor components of bulk photovoltaic, βᵢⱼ, and piezoelectricity, dᵢⱼ, can determine both the magnitude and direction of strains when a polarized excitation light 804 is irradiated onto the anisotropic ferroelectric material of the excitation element 806. I indicates the light intensity.

Acoustic wave can be generated in the excitation element 806 through photostrictive effect by rotating the optical polarization (time varying optical polarization angle, dθ/dt). With [001] direction represented by the subscript 3, the photostrictive strain component, ΔL₃, of the excitation element 806 in the above formula, which is irradiated by the polarized excitation light 804 with a time varying light polarization angle at an angular frequency w (θ = wt), can be expressed as

$$Δ {L}_{3} = Z ∗ I ∗ {d}_{33} ∗ \left[\left({β}_{31} - {β}_{33}\right) s i {n}^{2} \left(w t\right) + {β}_{33}\right]$$

Thus, the time varying light polarization can create the oscillating strain in the excitation element 806 by photostrictive effect and induce the acoustic wave in the structure mechanically coupled with the excitation element 806. As only polarization of the light varies with time in such excitation technique while the light intensity remains unchanged, contribution from photo-thermal induced acoustic can be eliminated.

FIG. 9 is a schematic representation of a light-acoustic coupling system 900 comprising a plurality of excitation elements, according to another example embodiment. A plurality of excitation elements 906 may be attached to the surface of the structure 908 based on a pre-defined pattern. The pre-defined pattern may comprise a periodicity. The excitation light 904 may be modulated at a modulation frequency based on the periodicity of the pre-defined pattern. The pre-defined pattern may further comprise an orientation. A direction of propagation of the acoustic wave 912 can be defined by the orientation of the pre-defined pattern. Generation of the directional acoustic wave 912 at a selected frequency when the excitation elements 906 are illuminated by the modulated excitation light 904 can be facilitated in this manner, such as through constructive contributions from individual excitation elements 906.

The excitation light 904 can be modulated in the form of light intensity or optical polarization modulations. The modulation frequency of the excitation light 904 may be determined by the periodicity of the pre-defined pattern (i.e. distance between each of the plurality of excitation elements 906) such that individual excitation element 906 can excite acoustic wave 912 in the mechanically attached structure 908.

In an example, the photostrictive strain in the individual excitation elements 906 can enhance the acoustic wave 912 in the structure 908 when the excitation elements 906 are spaced apart by a distance approximately equal to the wavelength of the acoustic wave 912. The resulting acoustic wave 912 with the selected frequency can propagate through the structure 908 in the direction defined by the arranged pattern of excitation elements 906 on the structure 908. The characteristic of acoustic wave 912 with pre-defined direction and frequency excited using the pre-defined pattern can be distinct from conventional photothermal induced broadband and omnidirectional acoustic wave. Improved properties of excited acoustic wave 912 at the selected frequency and modality can be achieved through constructive contributions from individual excitation elements 906.

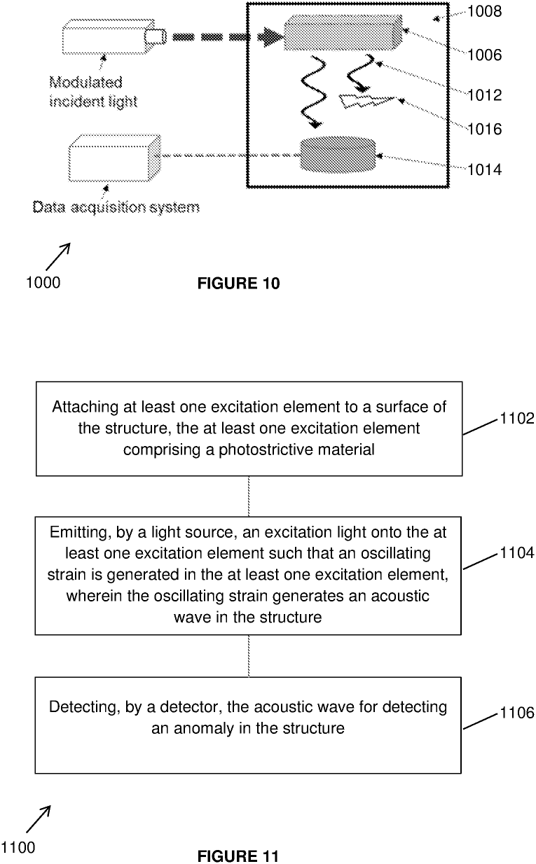

According to example embodiments, the detector to detect the acoustic wave may comprise a non-contact sensor or a contact sensor. FIG. 10 is a schematic representation of an anomaly detection method 1000 according to a light-acoustic coupling system comprising a contact sensor, according to an example embodiment. The detector may comprise a contact sensor 1014 disposed on the surface of the structure 1008. The acoustic wave 1012 induced through the excitation element 1006 in the structure 1008 mechanically attached to the excitation element 1006 can be detected by the contact sensor 1014, such as a piezoelectric transducer, disposed on the structure 1008. The acoustic wave 1012 induced by the excitation element 1006 can be sensitive to external stimuli and structural integrity, such as defects and/or anomalies 1016. Hence, the system 1000 for detecting an anomaly in the structure can be used for non-destructive testing, condition monitoring and structure health monitoring through detection of the defects and/or anomalies 1016 in the structure 1008.

Embodiments of the invention also provide a non-destructive testing system and a structural health monitoring system that comprise the system as described above.

Embodiments of the invention also provide a method for detecting an anomaly in a structure. FIG. 11 shows a flow chart 1100 illustrating an anomaly detection method according to an example embodiment. At step 1102, at least one excitation element is attached to a surface of the structure. The at least one excitation element comprises a photostrictive material. At step 1104, an excitation light is emitted by a light source onto the at least one excitation element such that an oscillating strain is generated in the at least one excitation element. The oscillating strain generates an acoustic wave in the structure. At step 1106, the acoustic wave is detected by a detector for detecting an anomaly in the structure.

According to an embodiment, the excitation light may be modulated based on a light intensity. According to another embodiment, the excitation light may be modulated based on an optical polarization.

The photostrictive material may comprise a ferroelectric material. The at least one excitation element may comprise a resonance frequency based on at least one of a shape, a pattern and a dimension of the at least one excitation element. The excitation light may be modulated at a modulation frequency based on the resonance frequency of the at least one excitation element.

According to an embodiment, a plurality of excitation elements may be attached to the surface of the structure based on a pre-defined pattern. The pre-defined pattern may comprise a periodicity. The excitation light may be modulated at a modulation frequency based on the periodicity of pre-defined pattern for achieving a constructive improvement effect. The pre-defined pattern can comprise an orientation. The acoustic wave may be detected along a direction of propagation of the acoustic wave defined by the orientation of the pre-defined pattern.

The detector for detecting the acoustic wave may comprise a non-contact sensor. Alternatively, the detector may comprise a contact sensor disposed on the surface of the structure.

Embodiments of the invention also provide a non-destructive testing method and a structural health monitoring method that comprise the method as described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A system comprising:
a light source configured to emit an excitation light;
at least one excitation element attached to a surface of a structure, the at least one excitation element comprising a photostrictive material and configured to receive the excitation light for generating an oscillating strain, wherein the oscillating strain generates an acoustic wave in the structure; and
a detector configured to detect the acoustic wave.

2. The system as claimed in claim 1, wherein the excitation light is modulated based on a light intensity.

3. The system as claimed in claim 1, wherein the excitation light is modulated based on an optical polarization.

4. The system as claimed in claim 1, wherein the photostrictive material comprises a ferroelectric material.

5. The system as claimed in claim 1, wherein the at least one excitation element comprises a resonance frequency based on at least one of a shape, a pattern and a dimension of the at least one excitation element.

6. The system as claimed in claim 5, wherein the excitation light is modulated at a modulation frequency based on the resonance frequency of the at least one excitation element.

7. The system as claimed in claim 1, comprising a plurality of excitation elements, wherein the plurality of excitation elements are attached to the surface of the structure based on a pre-defined pattern.

8. The system as claimed in claim 7, wherein the pre-defined pattern comprises a periodicity, and wherein the excitation light is modulated at a modulation frequency based on the periodicity of the pre-defined pattern.

9. The system as claimed in claim 7, wherein the pre-defined pattern comprises an orientation, and wherein a direction of propagation of the acoustic wave is defined by the orientation of the pre-defined pattern.

10. The system as claimed in claim 1, wherein the at least one excitation element comprises a cantilever.

11. The system as claimed in claim 1, wherein the acoustic wave is an ultrasonic wave with frequency above 20 kHz.

12-15. (canceled)

16. A method for detecting an anomaly in a structure, the method comprising:
attaching at least one excitation element to a surface of the structure, the at least one excitation element comprising a photostrictive material;
emitting, by a light source, an excitation light onto the at least one excitation element such that an oscillating strain is generated in the at least one excitation element, wherein the oscillating strain generates an acoustic wave in the structure; and
detecting, by a detector, the acoustic wave for detecting an anomaly in the structure.

17. The method as claimed in claim 16, further comprising modulating the excitation light based on a light intensity.

18. The method as claimed in claim 16, further comprising modulating the excitation light based on an optical polarization.

19. The method as claimed in claim 16, wherein the photostrictive material comprises a ferroelectric material.

20. The method as claimed in claim 16, wherein the at least one excitation element comprises a resonance frequency based on at least one of a shape, a pattern and a dimension of the at least one excitation element.

21. The method as claimed in claim 20, further comprising modulating the excitation light at a modulation frequency based on the resonance frequency of the at least one excitation element.

22. The method as claimed in claim 16, comprising attaching a plurality of excitation elements to the surface of the structure based on a pre-defined pattern, wherein the pre-defined pattern comprises a periodicity, and wherein the method further comprises modulating the excitation light at a modulation frequency based on the periodicity of pre-defined pattern.

23. (canceled)

24. The method as claimed in claim 22, wherein the pre-defined pattern comprises an orientation, and wherein detecting the acoustic wave comprises detecting along a direction of propagation of the acoustic wave defined by the orientation of the pre-defined pattern.

25. The method as claimed in claim 16, wherein the detector comprises a non-contact sensor.

26-28. (canceled)
